(19) United States
(12) Patent Application Publication
(10) Pub. No.: US 2025/0065291 A1
(43) Pub. Date: Feb. 27, 2025

(54) ROTARY DEVICE FOR THERMALLY TREATING FLUIDS AND RELATED METHOD

(71) Applicant: Coolbrook Oy, Helsinki (FI)

(72) Inventors: Alexander KARPOV, Helsinki (FI); Denis SEMENOV, Helsinki (FI); Vahid SUDZHADINOV, Helsinki (FI); Maksim SMIRNOV, Helsinki (FI); Natalia KUKLINA, Helsinki (FI); Antti SUIKKI, Helsinki (FI)

(21) Appl. No.: 18/811,403

(22) Filed: Aug. 21, 2024

(30) Foreign Application Priority Data
Aug. 24, 2023 (FI) 20235938

(51) Int. Cl. B01J 19/18; C10G 9/00

(52) U.S. Cl. CPC B01J 19/1806; C10G 9/00

(57) ABSTRACT

The present disclosure concerns a rotary apparatus (100) configured for inputting thermal energy (heat) into fluids by having fluidic stream repeatedly propagated through rotating and stationary components arranged inside said rotary apparatus in accordance with essentially helical trajectory. The rotary apparatus (100) comprises two or more rotor blade cascades (R1, R2) coaxially arranged on one or more rotor shaft(s), and at least two stationary vane cascades arranged upstream of a first rotor blade cascade (R1) and downstream of a rearmost rotor blade cascade (R2), respectively. In operation, fluid, such as gas, is heated inside the rotary apparatus while repeatedly passing through cascades S1-R1-R2-S2 in accordance with essentially helical trajectory. The rotor blade cascades can be configured to rotate in co- and counter directions and/or with the same or different speed. In some configurations the apparatus further comprises a flow turn cascade (FTC) configured as a stationary vane cascade arranged between successive coaxial rotor blade cascades (R1, R2). Related method for thermally treating fluids is further provided.

### FIELD OF THE INVENTION

The present invention relates to the field of rotary turbomachines. In particular, the invention concerns a rotary apparatus allowing for increased volumetric flow rate therethrough and configured for inputting thermal energy (heat) into fluids by having fluidic stream repeatedly propagated through rotating and stationary components arranged inside said rotary apparatus along essentially helical flow path.

### BACKGROUND

Concept of a rotary device comprising a rotor disk with associated blade cascade disposed between the rows of stationary vanes arranged on essentially ring-shaped supports and enclosed within a torus-shaped casing has been originally disclosed in the U.S. Pat. No. 9,494,038 (Bushuev). This design has been further developed by Seppälä et al, as disclosed in the U.S. Pat. No. 9,234,140 (Seppälä et al). Both disclosures concern a reactor device for converting hydrocarbon feedstocks into light olefins via thermo (chemical) cracking. Hydrocarbon feedstock-containing gas enters the interior of the apparatus via inlet(s) and passes through rotating and stationary cascades several times according to essentially spiral trajectory prior to exiting the reactor. In the reactor, the process gas is heated, in a stepwise fashion, to average cracking temperatures, such as about 750-1000 degrees Celsius (° C.), more typically 820-950° C., through formation of a series of shockwaves arising when the gas flow agitated to supersonic speed at a rotating cascade is decelerated at subsequent stationary diffusing cascade where kinetic energy is converted into heat. The reactor design by Seppälä et al (U.S. Pat. No. 9,234,140) aimed at controllably reducing residence times in the reaction zone in order to improve the yield of target olefins, mainly ethylene, and minimize formation of side products and coke.

Recently it has been demonstrated that the rotary bladed device(s), such as the ones described hereinabove, may be rendered with a (pre) heater functionality capable of providing significantly higher amounts of (thermal) energy into high temperature heat intensive processes and associated equipment. These are a variety of industrial processes such as for example processing of non-metallic minerals to manufacture cement for example, production of hydrogen from natural gas, incineration of end-of-life plastics, chemical industry high-temperature heat processes (e.g. core processes to crack hydrocarbons into bulk chemicals and to transform limestone to cement clinker), iron and steel production (e.g. core processes to melt and form steel) and utilization of thus produced off-gases as a feedstock for bulk chemicals. Most of the above-mentioned processes require high- and extremely high temperature, such as within a range of about 850° C. to about 1600° C. To provide enough thermal energy for such processes, known rotary bladed device(s) still have a room for improvement.

In this regard, an update in the field of improving efficiency of rotary bladed devices employed in thermal processing of fluids is still desired in view of addressing challenges associated with capability of said devices to generate heated media.

### SUMMARY OF THE INVENTION

An objective of the present invention is to solve or to at least alleviate each of the problems arising from the limitations and disadvantages of the related art. The objective is achieved by various embodiments of a rotary apparatus for inputting thermal energy into fluidic medium, related arrangements, methods and uses. Thereby, in one aspect of the invention an apparatus for inputting thermal energy into fluidic medium is provided, according to what is defined in the independent claim 1.

In an embodiment, a rotary apparatus is provided comprising:
a rotor comprising two or more circumferential rows of rotor blades coaxially arranged on at least one rotor shaft and forming respective rotor blade cascades;
at least two rows of stationary vanes adjacently disposed with regard to the rotor blade cascades and forming respective stationary vane cascades, wherein a first stationary vane cascade is arranged upstream of a first rotor blade cascade, and wherein a second stationary vane cascade is arranged downstream of a rearmost rotor blade cascade; and
a casing, in which a duct is formed with at least one inlet and at least one outlet, said casing enclosing rotor blade cascades and stationary vane cascades inside the duct,
   wherein said cascades are configured to direct a stream of fluidic medium propagating in the duct between at least one inlet and at least one outlet to repeatedly pass through said cascades according to essentially helical trajectory, and to heat the stream of fluidic medium by virtue of series of energy transformations occurring when said stream of fluidic medium successively passes through blade/vane rows formed by at least: the first stationary vane cascade, the rotor blade cascades, the second stationary vane cascade, and further through a portion of the duct between an exit from the second stationary vane cascade and an entrance to the first stationary vane cascade, respectively.

In an embodiment, in said rotary apparatus, the first stationary blade cascade is configured as a guide vane cascade formed with a plurality of stationary guide vanes, and the second stationary vane cascade is configured as a diffusing cascade formed with a plurality of stationary diffusing vanes.

In an embodiment, the rotary apparatus further comprises a flow turn cascade configured as a stationary vane cascade and arranged between successive coaxial rotor blade cascades. In an embodiment, the flow turn cascade is configured to turn the stream of fluidic medium exiting the first rotor blade cascade and to direct it towards a subsequent rotor blade cascade.

In an embodiment, in said rotary apparatus, each of the rotor blade cascades comprises a rotor blade cascade specific number of rotor blades, and wherein each of the stationary vane cascades comprises a stationary vane cascade specific number of stationary vanes.

In an embodiment, in said rotary apparatus, the rotor blade cascades are arranged on same rotor shaft configured to rotate in a predetermined direction. In another embodiment, the rotor blade cascades are arranged on connected, coaxially aligned rotor shafts. Direction of rotation and/or angular velocity/revolutions per minute (rpm) value for each rotor blade cascade arranged on different shafts can be independently regulated. In an embodiment, said connected, coaxially aligned shafts are configured for counter-rotation.

In an embodiment, in said rotary apparatus, the stationary vane cascades are coaxially centered with the rotor blade cascades arranged on the same rotor shaft or on separate, coaxially aligned rotor shafts.

In an embodiment, in said rotary apparatus, the portion of the duct between the exit from the second stationary vane cascade and the entrance to the first stationary vane cascade is essentially free of blades/vanes and/or any other structures.

In another aspect, use of the rotary apparatus according to some previous aspect and embodiments for generation of fluidic medium heated to the temperature essentially equal to or exceeding about 400 degrees Celsius (° C.) is provided, according to what is defined in the independent claim 12.

In another aspect, use of the rotary apparatus according to some previous aspect and embodiments for heat-assisted conversion of feedstocks in fluidic media, optionally, as a reactor for thermal- or thermochemical cracking of hydrocarbon-containing feedstocks, is provided, according to what is defined in the independent claim 13.

In a further aspect, an assembly comprising at least two rotary apparatuses according to some previous aspect and embodiments, at least functionally connected in parallel or in series, is provided, according to what is defined in the independent claim 14.

In still further aspect, an arrangement comprising at least one rotary apparatus according to some previous aspect and embodiments and connected to at least one heat-consuming unit is provided, according to what is defined in the independent claim 15. In embodiments, in said arrangement, the heat-consuming unit is any one of: a furnace, an oven, a kiln, a reactor, a heater, a burner, an incinerator, a boiler, a dryer, a conveyor, or a combination thereof.

In an aspect, a method for inputting thermal energy into fluids is provided, according to what is defined in the independent claim 17.

The utility of the present invention arises from a variety of reasons depending on each particular embodiment thereof. Overall, the presented invention concerns a rotary device enclosed into a toroid-shaped casing comprising two or more impeller units, which enables realization of a new gas-dynamic scheme in such a device and leads to efficiency improvements. This is achieved by having a volumetric flow rate (of fluid/gas flowing through the device) increased at least 1.5 times, while essentially preserving the size of the device. Due to increased volume of fluid/gas which passes through the proposed device per unit time, efficiency of the rotary device, in terms of its capability of converting mechanical energy of the rotor to heat and hence produce increased amounts of heated fluid/gas per unit time, is improved.

Provision of the rotary apparatus with two or more impeller units mounted on same or different rotor shafts allows for adjusting the heating process such that more heat can be inputted into fluids by operating the rotary apparatus at lower rotational speed, as compared to known devices described herein above. Alternatively, if rotational speed is preserved same or equivalent to those used in the known devices, the apparatus of the invention allows the fluids to be heated to higher temperatures. The expression “a number of” refers hereby to any positive integer starting from one (1), e.g. to one, two, or three. The expression “a plurality of” refers hereby to any positive integer starting from two (2), e.g. to two, three, or four. The terms “first” and “second”, are used hereby to merely distinguish an element from another element without indicating any particular order or importance, unless explicitly stated otherwise.

The term “gasified” is utilized herein to indicate matter being converted into a gaseous form by any possible means.

Different embodiments of the present invention will become apparent by consideration of the detailed description and accompanying drawings.

### BRIEF DESCRIPTION OF THE DRAWINGS

FIG. 1A illustrates vertical crosscut of a rotary apparatus 100 according to an embodiment and FIG. 1B schematically illustrates an arrangement of rotating and stationary blades/vanes therein.

FIGS. 2A and 3A illustrate vertical crosscut of a rotary apparatus 100 according to another embodiment.

FIG. 2B schematically illustrates an arrangement of rotating and stationary blades/vanes in the apparatus shown on FIG. 2A.

FIG. 3B shows cross-sectional views across lines A-A and B-B designated on FIG. 3A and illustrates a flow diagram for streamline passageways through the apparatus 100.

FIGS. 4A and 4B are streamline comparison charts (crosscut A-A at the rotor R1 entry plane) to illustrate the differences between a known rotary apparatus with a single rotor blade cascade (FIG. 4A, prior art) and the rotary apparatus 100 according to some embodiments.

FIG. 5A schematically illustrates a blade/vane layout for the rotary apparatus 100, 100A with rotor blade cascades adapted to rotate in opposite directions towards each other, and FIG. 5B schematically illustrates the same for the rotary apparatus 100, 100B with rotor blade cascades adapted to rotate in same direction.

### DETAILED DESCRIPTION OF THE EMBODIMENTS

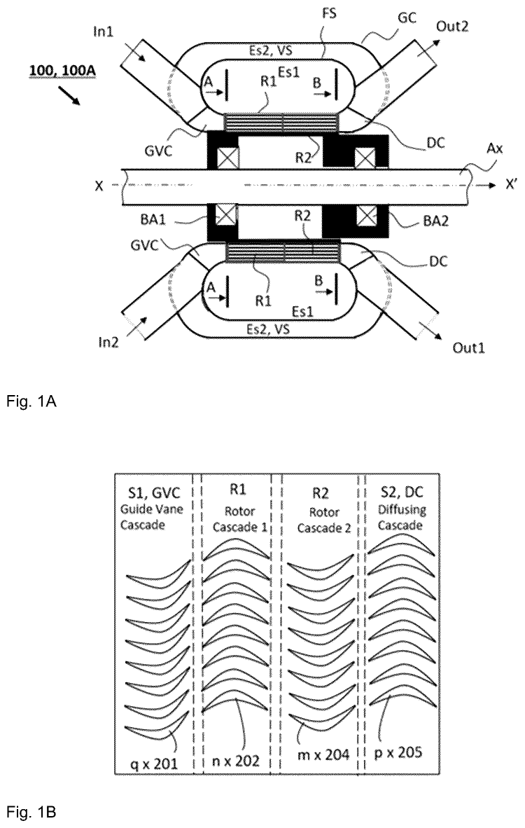

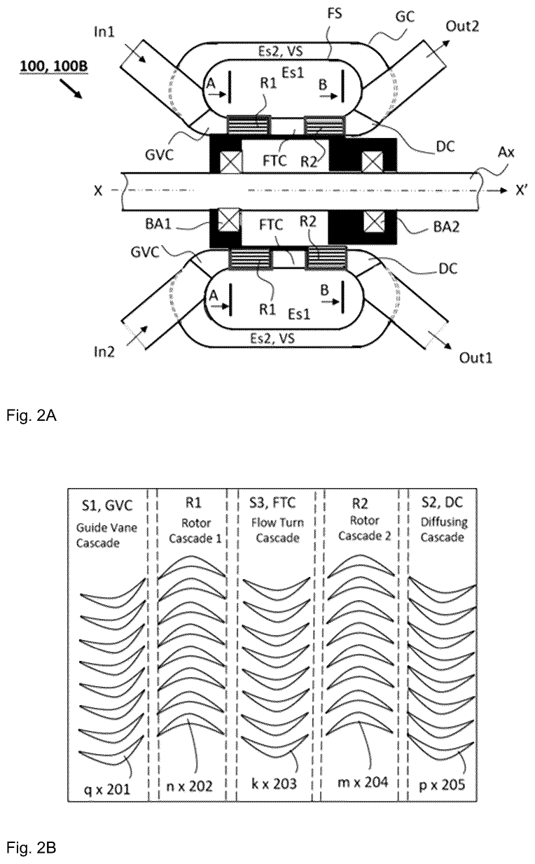

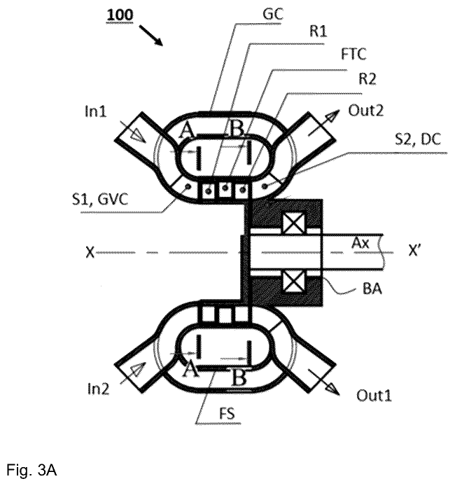

FIGS. 1A and 2A schematically illustrate, at 100A and 100B, respectively, exemplary embodiments underlying a concept of a rotary apparatus 100, hereafter, an apparatus, for inputting thermal energy into fluids.

Overall, the apparatus 100 is configured to provide improvements to the devices disclosed in patent documents U.S. Pat. No. 9,494,038 to Bushuev and U.S. Pat. No. 9,234,140 to Seppälä et al. Similarly to these known devices, the apparatus 100 transfers the mechanical energy of rotating shaft to fluidic media and converts it into internal energy of the fluid through a set of rotating and stationary blade cascades. However, the apparatus 100 presented herewith enables increasing a volumetric flow rate through the apparatus at least 1.5 times compared to the above referenced known devices without increasing a diameter of the apparatus and with only negligible increase in its length. Efficiency of the device, in terms of conversion mechanical energy of the rotor to thermal energy (heat) is markedly increased.

The apparatus 100, 100A, 100B is preferably configured for heating fluids. The apparatus is adapted for (direct) heating of fluids, preferably gasses, passing therethrough in a manner disclosed hereinbelow. In embodiments, the apparatus 100, 100A, 100B can be advantageously used for generation of fluidic medium heated to temperatures essentially equal to or exceeding about 400° C. In embodiments, the apparatus is configured to generate fluidic medium heated to temperatures essentially equal to or exceeding about 1000° C., preferably, to temperatures essentially equal to- or exceeding about 1400° C., still preferably, to temperatures essentially equal to or exceeding about 1700° C. Temperatures up to 2000-2500° C. can be achieved upon application of appropriate cooling technologies.

Feed fluid may include one of: a feedstock liquid or gas, such as naphtha, LPG, methane, ethane, natural gas, or any other suitable hydrocarbon-based feedstock, a process gas/working gas, a make-up gas (a so-called replacement/supplement gas), a recycle gas, and the like. Liquid feedstocks, such as naphtha etc. are preferably diluted with steam, for example. Gaseous feed can include inert gases (steam, air, nitrogen gas, and the like) or reactive gases (e.g. oxygen), flammable gases, such as hydrocarbons, or any other gas. Additionally or alternatively, feed fluid may include any one of: (water) steam, nitrogen (N₂), hydrogen (H₂), carbon dioxide (CO₂), carbon monoxide (CO), and ammonia (NH₃). Selection of fluid to be heated by the apparatus 100, 100A, 100B depends on requirements of industrial process(-es), in which said fluid will be utilized. Indeed, a specific industry/an area of industry said heat-consuming process is assigned to implies certain requirements and/or limitations on selection of feed substance(s).

Fluid heated by the apparatus 100, 100A, 100B may be further utilized for (indirectly) heat any other gaseous, liquid, solid or particulate matter, or combination thereof, via a process of heat transfer between the heated fluidic medium generated in the rotary apparatus and a suitable medium (solid, liquid, etc.) exploited by the exemplary heat-consuming process.

In some instances, inputting of thermal energy into said fluids resulting in generating heated fluids may be accompanied with a series of chemical reactions resulting in thermal or thermochemical conversion of feedstocks. Conversion may include reactions of thermal and/or (thermos) chemical degradation occurring while the feedstock containing process fluid propagates through the apparatus. In some instances, the apparatus 100, 100A, 100B may thus be configured as a reactor for (thermo) chemical cracking of hydrocarbon-containing feedstocks, in particular, for steam cracking of hydrocarbon-containing feedstocks, such as naphtha(s), to produce lower olefins (ethylene, propylene, etc.). By “hydrocarbon-containing feedstock” we refer hereby to fluidized organic feedstock matter that primarily comprises carbon- and hydrogen. In similar manner, the apparatus 100, 100A, 100B may be adapted for thermal decomposition of chlorinated hydrocarbons, such as 1,2-dichloroethane (ethylene dichloride, EDC), for example, to produce vinyl chloride monomer, and the like. In some other instances apparatus may be configured to process oxygen-containing feedstock matter, such as oxygen-containing hydrocarbon derivatives, cellulose-based feedstock and/or vegetable oil-based feedstocks.

It is preferred that the feed enters the apparatus 100 in essentially gaseous form. Preheating of feed or conversion of liquid and essentially liquid feed(s) into a gaseous form can be performed in an optional preheater unit (not shown).

The apparatus 100, 100A, 100B comprises a rotor system, hereafter, a rotor, comprising at least one rotor shaft Ax positioned along a horizontal (longitudinal) axis X-X′ and two or more circumferential rows of rotor blades (also referred to as working blades), coaxially arranged on said at least one shaft. In typical configurations, a plurality of rotor blades is arranged into a circumferential row over a periphery of a rotor disk or a rotor hub mounted on the rotor shaft to form a rotor blade cascade (working blade cascade). Hence, the apparatus comprises two or more circumferential rows of rotor blades coaxially arranged on at least one shaft Ax and forming respective rotor blade cascades R1, R2. In some instances, the essentially annular assemblies of rotor blades (rotor blade cascades) arranged on related rotor disks are referred to as “impellers”, to emphasize that the rotor system of the apparatus 100, 100A, 100B comprises more than one rotating component.

FIGS. 1A, 2A and 3A show the rotary apparatus comprising two rotor blade cascades (also referred to as impellers). Devices with three- or four rotor blades cascades can be realized in similar manner. Realization of the devices with more than four rotor blades cascades is not excluded; however, additional considerations in view of solving at least turbulence issues apply.

At least one rotor shaft Ax is rotated by a suitable drive engine/motor to provide rotational angular velocity to each of the impellers/rotor blade cascades R1, R2. In some configurations, the apparatus utilizes electric motor(s) as a drive engine. Additionally or alternatively the apparatus can be driven directly by a power turbine, such as gas- or steam turbine, for example, or by any other suitable drive engine device. For the purposes of the present disclosure, any appropriate type of electric motor (i.e. a device capable of transferring energy from an electrical source to a mechanical load) can be utilized. Suitable coupling(s) arranged between a motor drive shaft and the rotor shaft, as well as various appliances, such as power converters, controllers and the like, are not described herewith. Bearing assemblies with related shaft end seals denoted as BA, BA1, BA2 are indicated on FIGS. 1A, 2A and 3A. The rotor is preferably provided with a damping system (not shown) to damp vibrations, that may originate from various sources, such as for example flow turbulence related phenomena.

The apparatus 100, 100A, 100B further comprises a stationary component. Stationary component is represented with two or more rows of stationary blades or vanes adjacently disposed with regard to coaxial impellers/rotor blades cascades and forming respective stationary vane cascades (S1, S2) with a plurality of stationary (stator) vanes arranged into rows. In the present disclosure, we refer to working- or rotor blades with the term “blades” and to stationary blades—with the term “vanes”. In embodiment, stationary vane cascades S1, S2 are provided as essentially annular assemblies at both sides of the rotor blade cascades R1, R2.

A first stationary vane cascade S1 is thus arranged upstream of a first impeller/rotor blade cascade R1, and a second stationary vane cascade S2 is arranged downstream of a rearmost impeller/rotor blade cascade R2. The rearmost or last impeller/rotor blade cascade is any one of second, third, fourth, etc. impellers in a sequence of impellers/rotor blade cascades coaxially arranged on the rotor shaft Ax along the axis X-X′ (direction along the rotor shaft is indicated on FIGS. 1A and 2A with an arrow). Accordingly, first (or foremost) impeller/rotor blade cascade is a first impeller/cascade of rotor blades in a sequence of coaxial impellers/working blade cascades.

The term “cascade” (a crown of blades/vanes) refers to an ensemble of (working) blades or (stationary) vanes installed over a periphery of a rotor disk/rotor hub (for working blades) or on a ring-shaped support installed within casing or on an internal wall/lining of the casing (for stationary vanes), respectively.

The terms “upstream” and “downstream” refer hereby to spatial and/or functional arrangement of structural parts or components with relation to a predetermined part- or component, hereby, the rotor, in a direction of fluidic flow stream throughout the apparatus (from inlet to exit).

In exemplary configuration shown on FIG. 1A, the rows of working blades and stationary vanes are arranged into a cascade arrangement (S1-R1-R2-S2), in which the first stationary vane cascade (S1) is arranged upstream of the first rotor blade cascade (R1) and wherein the second stationary vane cascade is arranged downstream of the second rotor blade cascade (R2). Related arrangement of rotating and stationary blades/vanes for the apparatus 100A is shown on FIG. 1B.

Stationary vane cascade arranged upstream of the first row of rotor blades (viz. first stationary cascade, S1) preferably comprises a plurality of stationary guide vanes and hence is referred to as a guide vane cascade, GVC. Stationary guide vanes can be configured as stationary nozzle guide vanes, NGV. Stationary vane cascade arranged downstream of the rearmost row of rotor blades (viz. second stationary cascade, S2) comprises a plurality of stationary diffusing (or diffuser) vanes and hence is referred to as a stationary diffusing (or diffuser) cascade, DC.

FIG. 2A shows the rotary apparatus 100 embodied at 100B and comprising, in addition to components described for configuration 100A, a flow turn cascade (or flow turning cascade), FTC, configured as a third stationary vane cascade. The flow turn cascade is arranged between successive coaxial impellers/rotor blade cascades R1, R2. FTC is advantageously configured to turn the fluid flow, exiting the first impeller/rotor cascade R1, and to direct this flow towards a subsequent impeller/rotor cascade R2. This is achieved by having the FTC vanes (203, see below) designed and installed within the apparatus such that their leading edges face the first rotor blade cascade R1 and trailing edges face the subsequent rotor blade cascade R2. FIG. 2B shows the arrangement of rotating and stationary components in the apparatus 100B.

It is noted that configurations involving more than two impellers may comprise at least two flow turning cascades (S3, FTC) to separate rotor blade rows (not shown). By way of example, configuration with three impellers/rotor blade cascades may be represented with a sequence: S1 (GVC)-R1-FTC1(S3)-R2-FTC2(S4)-R3-S2 (DC). First and second flow turning cascades (FTC1 and FTC2) are provided as stationary components.

With the term “stationary” we refer to blades/vanes not rendered with rotational movement around the axis X-X′ (as contrary to the rotor blades). It is noted that attachment of stationary vanes to the casing (internal wall or lining thereof) may be fixed (non-movable) or essentially movable. In a latter case attachment of stationary vane(-s) may employ some degree of movement, allowing adjustment of the blade angle, to some extent, with regard to the rotor blades and/or the interior of the casing. Stationary blades/vanes may be attached directly to the casing (internal wall and/or lining thereof) or via auxiliary connector means such as for example rails, ring-shaped support frame, etc. Movable connection may be realized by hinged joints, or any other appropriate connection means. Thus, flow turning vanes (FTC) may be connected via such movable connection to the casing, for example, in order to adjust angle/direction of fluid flow for smooth transfer between rotor blades. In some exemplary configurations the flow turning vanes may be configured to turn the flow by 60-120 degrees.

Each blade row (including rotating blade cascades R1 and R2, and stationary cascades S1, S2, S3) is formed of a plural number of blades (which are referred to as “vanes” with regard to the stationary components). As visualized by FIGS. 1B and 2B, each of the rotor blade cascades R1, R2 comprises a rotor blade cascade specific number (n), (m) of rotor blades 202, 204, respectively, and each of the stationary vane cascades S1, S2, S3 comprises a stationary vane cascade specific number (q), (k), (p) of stationary vanes 201, 203, 205, respectively.

Any one of said blades/vanes 201, 202, 203, 204, 205 is formed by a shell extending from a root section to a tip section at different and variable radius. Root-to-tip radius ratio (also referred to as hub-to-tip radius ratio for rotating blades) and/or blade angle(s) is/are configured variable to guide fluid(s) along a flow path required/desired in each particular implementation of the apparatus 100. The blade/vane rows S1-R2-R2-S2 or S1-R1-FTC(S3)-R2-S2 can thus be configured to implement any one of axial, radial or diagonal flow paths, or a combination thereof. Number (q, n, k, m, p) of blades/vanes in the row can be adjusted as needed. Clearance spaces between rotating and stationary rows and marked on FIGS. 1B and 2B with dashed lines. The clearance spaces provide operational clearance and separation for blades/vanes of adjacent rows in order to eliminate potential collision risks due to vibrations and/or thermal expansion.

Blade/vane design depends on realization of the apparatus 100. Variable parameters include the shape of the blade, airfoil profile, blade inlet- and the blade exit angles, blade root-to-tip radius ratio, spacing between consecutive blades (pitch), and the like. By altering these parameters, a variable passage channel geometry between the adjacent blades is created in order to achieve required/desired pressure and/or temperature conditions within the fluid. Said space/passage between individual blades/vanes within stationary and rotating cascades may be adjusted individually within each cascade or collectively for all stationary and rotating cascades as required for flow conditioning purposes.

The apparatus 100, 100A, 100B (FIGS. 1A, 2A) comprises a casing referred to as a gas casing (GC) or a pressure casing, in where an interior passageway is established in the form of a duct between at least one inlet (In) and at least one outlet (Out). The casing GC is hermetically (gas-tight) sealed.

In present disclosure, the gas casing GC is generally referred to as an apparatus casing. Nevertheless, the apparatus structure 100 can be further enclosed into a separate external housing (not shown).

FIGS. 1A, 2A and 3A show the apparatus 100 with two inlets In1, In2 and two outlets Out1, Out2; other configurations may be conceived where appropriate. The inlet(s) and outlet(s) comprise related orifices or ports in the casing GC and a number of branch pipes, sleeves or manifolds associated with each said orifice/port.

In the apparatus 100, 100A, 100B, the casing GC is configured to substantially fully enclose the periphery of impellers with working blades (rotor blade cascades R1, R2) and stationary vane cascades S1, S2 and, S3 (GVC, DC and FTC, respectively) that adjoin the rotor blades from one or both sides thereof. The casing GC has an essentially toroid shape in three-dimensional configuration, whereby the rotor system (Ax, R1, R2) with related bearing assemblies BA may be viewed as filling up an aperture defining an opening in the central part of the essentially toroid shape. The toroid-shaped structure thus forms a gas-tight gas casing. At its meridional cross-section, the gas casing GC is essentially ring-shaped.

A flow-shaping device (a flow-guiding device) FS is arranged inside the gas casing GC. The flow-shaping device FS can be configured as an internal stationary ring-shaped structure, and it accounts for establishing an essentially annular cavity (duct) inside the casing GC. The device FC is fixed in the gas casing GC with appropriate fixtures (not shown). In some configurations, the flow-shaping device FS is an annular, essentially hollow structure, such as a hoop, for example. Toroidal volume inside the flow-shaping device FS is designated on FIGS. 1A and 2A as Es1.

A substantially annular passageway/duct is thus formed between an inner surface of the gas casing GC and an outer surface of the flow-shaping device FS. This duct (space established between the gas casing GC and the flow-shaping device FS) defines an interior volume of the apparatus 100, in which fluidic stream is propagated. The duct may be further referred to as a gas channel.

The duct has a ring-shaped meridional cross-section, accordingly. The flow-shaping device FS may adjoin the tips of rotor blades (a gap is formed therebetween enabling unhindered rotation of the rotor) and the peripheral portions of stator vanes, in an event the stator vanes are provided on bearing blocks constituting a bearing system of the rotor (not shown). Toroidal volume inside the duct is designated on FIGS. 1A and 2A as Es2.

Alternatively, the stator cascades S1, S2, S3 may be assembled on the flow-shaping device FS in a manner to adjoin the rotor blades of the cascades R1, R2. Said stator vanes may thus be mounted on the flow-shaping device and/or connected thereto by means of auxiliary arrangements, such as rings, brackets, and the like (not shown). The above-mentioned features are discussed in more detail in patent documents by Bushuev (U.S. Pat. No. 9,494,038 B2) and Seppälä et al (U.S. Pat. No. 9,234,140) referenced hereinabove.

In the duct formed inside the gas casing GC, the cascades S1, R1, R2, S2 (and, where applicable, FTC (S3) positioned between impellers/rotor blade cascades R1 and R2) adjoin each other in such a way that a portion of the duct between an exit from the second stationary vane cascade S2 and an entrance to the first stationary vane cascade S1 remains essentially hollow (i.e. empty of any structures). This essentially hollow portion of the duct (Es2) formed with a space between the inner surface of the gas casing GC and the outer surface of the flow-shaping device FS is therefore referred to as a vaneless space (VS).

In the apparatus 100, cascades S1, R1, R2, S2, and, where applicable FTC (S3), are configured to direct a stream of fluidic medium propagating in the duct between at least one inlet (In, In1, In2) and at least one outlet (Out, Out1, Out2) to repeatedly pass through said cascades according to essentially helical trajectory, and to heat the stream of fluidic medium by virtue of series of energy transformations occurring when said stream of fluidic medium successively passes through blade/vane rows formed by at least: the first stationary vane cascade (S1), the rotor blade cascades (R1, R2), the second stationary vane cascade (S2), and further-through the portion of the duct between an exit from the second stationary vane cascade (S2) and an entrance to the first stationary vane cascade (S1), respectively.

In embodiments, the stream of fluidic medium following the essentially helical flowpath in the duct is heated when passing through the first stationary vane cascade S1, the first rotor blade cascade R1, the flow turning cascade (configured as stationary vane cascade), the second rotor blade cascade R2, the second stationary vane cascade S2, and the portion of the duct between an exit from the second stationary vane cascade S2 and an entrance to the first stationary vane cascade S1, respectively. First and second stationary vane cascades S1 and S2 are preferably configured as a guide vane cascade (GVC) and diffusing cascade (DC), respectively.

As described above, the portion of the duct between an exit from the second stationary vane cascade (S2) and an entrance to the first stationary vane cascade (S1) is configured essentially void of any structures and hence referred to as a vaneless space (VS).

Energy transformation/energy conversion cycle is completed when the stream of fluidic medium has passed through the sequences of blades/vanes comprising: S1-R1-R2-S2-VS or S1-R1-FTC-R2-S2-VS. Configurations with more than two rotor blade rows (R1, R2, R3) and more than one flow turning cascade (e.g. two flow turning cascades: FTC1, FTC2) can be conceived as described hereinabove. However, independent on a number of impellers and stationary blade rows in the rotary apparatus 100, full energy transformation/energy conversion cycle is completed when the stream of fluidic medium has propagated between blade/vane cascades and the vaneless space and has returned to the entrance of the first stationary vane cascade S1 (on its way along the essentially helical flowpath, as described in more detail herein below). During such energy conversion cycle, temperature of the fluid propagated through the duct (Es2) rises to a predetermined value (tₙ).

During the energy conversion/energy transfer cycle, the stationary guide vanes (S1, GVC) disposed upstream of the first rotor blade cascade R1 prepare required flow conditions at the entrance of R1. In terms of profiles, dimensions and disposition thereof around the rotor shaft, stationary guide vanes are configured to direct the fluid flow into the first rotor blade cascade in a predetermined direction such, as to control and, in some instances, to maximize the rotor-specific work input capability.

During passing through the GVC, the flow receives a circumferential velocity component and its velocity increases. In the first and each subsequent rotor blade cascade, mechanical energy of the rotor shaft and rotating blades is transferred to fluidic stream, and the flow is given an increment of kinetic energy. The fluid flow exits the rearmost rotor blade cascade and enters stationary diffusing cascade S2, DC at supersonic speed (at which the dimensionless Mach number exceeds 1). In the diffusing vane cascade (S2, DC) the flow is decelerated, and the temperature of the fluid rises by a predetermined value (delta t, Δt) because of conversion of kinetic energy into enthalpy due to significant drop in fluid velocity. The delta t value thus reflects the difference in fluid temperature before and after completion of the energy conversion cycle, and it may vary within about 100-300° C. Due to toroid-shaped design, the flow is forced to pass through impellers and stationary vane cascades a number of times, following the essentially helical or spiral flowpath. With each regenerative pass, the temperature of the fluid increases incrementally by a predetermined temperature value (Δt1, Δt2, Δt3, etc.), and the desired fluid temperature is typically achieved at few (3 to 5) last passes.

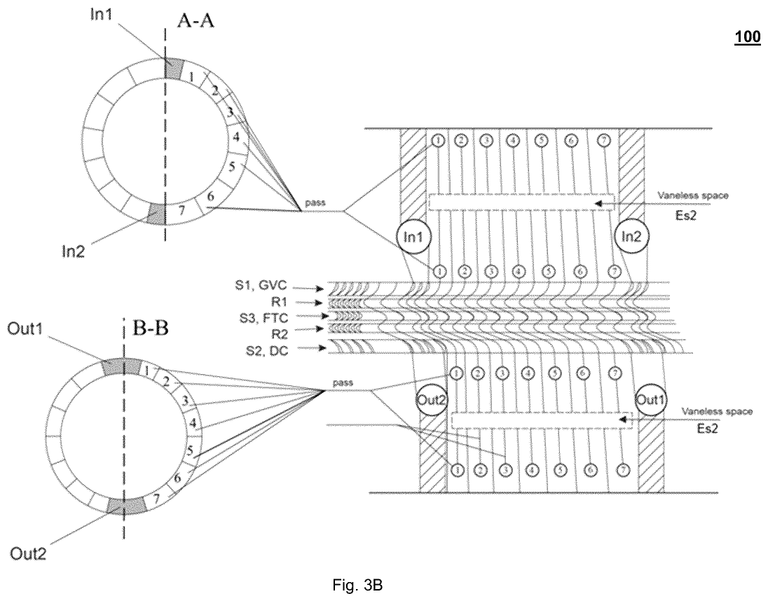

FIG. 3B illustrates cross-sectional views across lines A-A and B-B designated on FIG. 3A. Cross-sectional area across the line A-A is located at the entrance to the first stationary vane cascade (S1) configured as the guide vane cascade GVC, while cross-sectional area across the line B-B is located at the exit from the second stationary vanes cascade (S2) configured as the diffusing cascade DC. Overall, crosscuts A-A and B-B depict the events occurring at in the gas cavity (duct) of the rotary apparatus from the moment the fluid stream enters the apparatus through the inlet(s) and until the heated fluid stream is discharged from the apparatus via outlet(s).

Entrance and exit to- and from each blade/vane cascade are generally defined with leading edges and trailing edges, respectively, of related blades/vanes, in the direction of fluid flow.

On FIG. 3B, locations at which the fluidic stream enters and exits the interior of the apparatus 100 (the duct) are indicated (In1, In2, Out1, Out2). Flow diagram illustrative of streamline passageways through the apparatus is shown on the right. Fluidic streamlines passing through stationary and rotating blade cascades generally following the helical pathway are indicated as separate numbered sectorial areas or sectors by numerals 1-7. FIGS. 3A and 3B thus illustrate configuration 100, 100 (also shown on FIGS. 2A, 2B) comprising two impellers and two rotor blade cascades R1, R2, respectively with the stationary flow turn cascade FTC installed between the impellers. FIG. 3B shows streamlines travelling between a first inlet In1 and a first outlet Out1. Streamlines travelling between the second inlet In2 and the second outlet Out2 are not shown.

In operation, a stream of fluidic medium, optionally preheated, enters the apparatus 100 through the inlet In (In1) and arrives at the first stationary vane cascade S1, viz. guide vane cascade GVC. Fluid stream propagates through guide vanes, rotor blades of the first impeller, flow turn vanes, rotor blades of the second impeller, and diffusing vanes; thereafter the stream exits the cascade(s) at a sector “1” of the diffusing cascade (crosscut B-B), and flows “upwards” to the vaneless portion of the duct (vaneless space, VS). The flow enters vaneless space after it has exited the stationary diffusing vane cascade DC.

After having passed the vaneless space, fluid stream arrives at sector “1” of the GVC (crosscut A-A) and the above-described process is repeated. Namely, the fluid stream proceeds through the same cascades GVC-R1-FTC-R2-DC, exits at the sector “2” of the diffusing cascade DC (crosscut B-B) and continues through the vaneless space towards sector “2” of the GVC (crosscut A-A), generally following the helical pathway. In configuration presented on FIG. 3B, the stream propagates through the cascades seven (7) times (makes seven regenerative passes), where with each pass the temperature of fluid increases by the value of delta t, as described above. After the last pass, heated fluid stream exits the cascades and proceeds to the outlet Out (Out1) to be discharged from the apparatus.

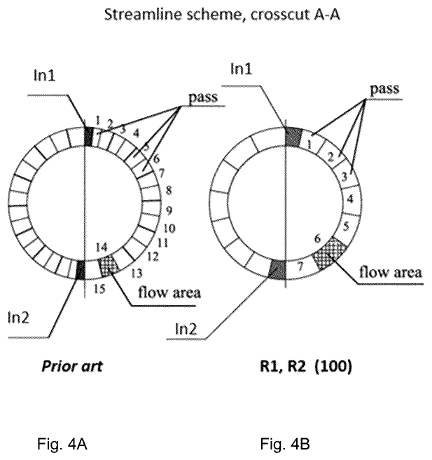

Because of more than one working blade row in the gas cavity (duct, Es2), temperature jump (delta t) achievable in one energy conversion cycle (in one regenerative pass) is increased about 1.5 times in comparison to the same achievable in known devices having a single rotor blade cascade. Therefore, the fluid can be heated to a certain temperature in a fewer number of regenerative passes, as illustrated with a comparison chart of FIG. 4A and FIG. 4B. FIG. 4B thus shows crosscut A-A of the double-impeller apparatus 100 of FIG. 3A. FIG. 4A shows crosscut A-A of a known rotary apparatus, as disclosed in Seppälä et al, for example, having a rotor with a single blade cascade (prior art apparatus is not shown).

Due to reduced number of regenerative passes the stream needs to make through the blades/vanes in order to achieve a required temperature, the area occupied by the fluid stream during passing through said blades/vanes is greater in the disclosed apparatus 100 in comparison to known devices, which results in an increased volumetric flow rate. This allows for achieving essentially the same heating temperatures at lower rotor speed, as compared to known rotary devices with a single impeller enclosed into a torus-shaped casing.

The apparatus 100 can be configured with the rotor system, in which two or more impellers are arranged on single or multiple shafts. For example two-shaft configuration may be conceived with coaxially aligned and connected rotor shafts. Provision of said connected rotor shafts may be realized via a suitable coupling or a nested shaft system for example.

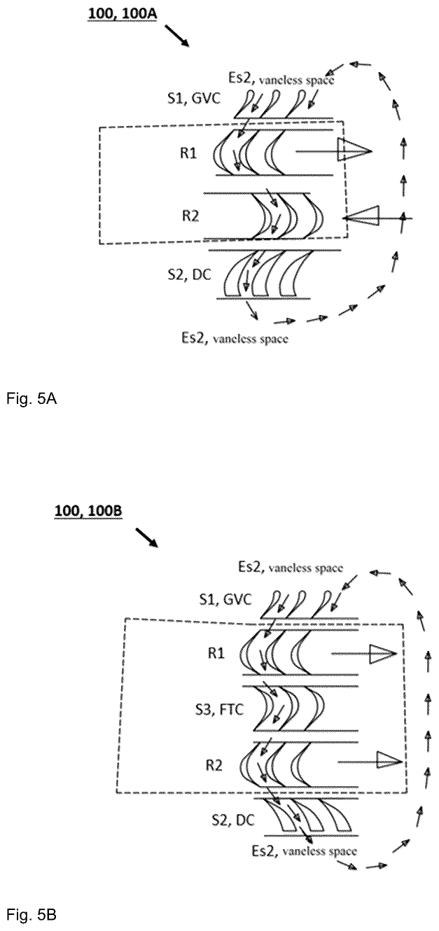

Configuration involving connected rotor shafts allows for enabling counter-rotation of the impellers. Configuration having two impellers rotating in opposite directions is presented on FIG. 5A; and configuration having two impellers rotating in the same direction is presented on FIG. 5B. Direction of rotation of the rotor is indicated with large horizontal arrows. Typically, the rotor is set to rotate toward a concave side (also called a pressure side) of the working blade airfoil. Direction of fluid flow through blade/vane cascades is indicated with small arrows to show a fragment of essentially helical pathway through said cascades.

It is noted that in configuration of FIG. 5A employing two impellers R1, R2 configured for counter-rotation (in practice, towards each other), provision of FTC may be omitted. Provision of FTC is preferred in configuration of FIG. 5B employing two impellers configured for co-rotation, in order to enable smooth and homogenous transition of the flow between the rotor blade rows and to minimize turbulence.

By having the impellers arranged on different rotor shafts, direction of rotation and/or angular velocity/revolutions per minute (rpm) value for of each impeller R1, R2 can be independently regulated. Each shaft could have same or different rotational speed according to the specific duty required. In this manner, angular (rotational) speed of impellers R1 and R2 in configurations of FIGS. 5A and 5B can be adjusted independently.

FIG. 5A thus illustrates vertical crosscuts through blades/vanes in same configuration as shown FIG. 1B. This configuration is generally preferred in terms of working blade profile for counter-rotating rotors, where the rotor rotates toward the concave side of the working blade airfoil.

In an event two or more impellers/rotor blade cascades are installed on the same shaft Ax, these rotor blades cascades rotate in a synchronized manner, to the same direction with identical angular velocity in respect to the blade tips speed in the circumferential motion. As mentioned hereinabove, rotor blades, typically having a curved, convex side and a concave side, are installed on the disk with their concave side in a direction of rotor rotation. In an absence of flow guiding/flow turning vanes in between, transition of flow between impellers rotating in the same direction is likely to be accompanied with turbulence; therefore, provision of FTC between rotor blade cascades R1, R2 is desirable, as shown on FIG. 5B.

Overall, configurations with e.g. two working blade cascades R1, R2 installed on connected, co-axially aligned shafts, provide greater flexibility for adjustment of rotation direction, angular velocity, etc. of each rotor cascade. In some instances, the flow turn cascade may be installed, in the rotary apparatus 100, on a detachable support, such as an internal ring, for example, that could be relatively easily dismounted and removed from the apparatus. In such an event, the rotary apparatus 100 configured for co- and counter-rotation (by virtue of separate rotor shafts) may be realized, with the FTC provided as a separate part mountable into the apparatus when the co-rotation mode is desired/required. For counter-rotation, each rotor shaft may be connected to a separate drive unit.

Upon connecting at least two apparatuses 100, 100A, 100B in parallel or in series, an assembly can be established. Connection between said apparatuses can be mechanical and/or functional. Functional (in terms of processing similar feedstocks, for example) connection can be established upon association between at least two physically integrated- or non-integrated individual apparatus units 100. In a latter case, association between the at least two apparatuses 100 can be established via a number of auxiliary installations. In some configurations, the assembly comprises the at least two apparatuses at least functionally connected via their central shafts such, as to mirror each other. Such mirrored configuration can be further defined as having at least two apparatuses 100 mechanically connected in series (in a sequence), whereas functional (e.g. in terms of inputting heat into fluids) connection can be viewed as connection in parallel (in arrays). In some instances, the aforesaid “mirrored” assembly can be further modified to comprise at least two inlets and a common exhaust (discharge) stage placed essentially in the center of the assembly (not shown).

Upon connecting the at least one rotary apparatus 100, 100A, 100B or the assembly of at least two apparatuses 100, 100A, 100B to at least one heat-consuming unit, an arrangement may be established. The apparatus(es) 100, 100A, 100B may be connected to the heat-consuming unit or units directly or indirectly, e.g. through a number of heat exchangers. The heat-consuming unit may be provided as any one of: a furnace, an oven, a kiln, a reactor, a heater, a burner, an incinerator, a boiler, a dryer, a conveyor, or a combination thereof.

Said arrangement including the at least one apparatus 100, 100A, 100B and at least one heat-consuming unit may be provided as a part of a heat-consuming system configured as a facility adapted to carry out at least one heat-consuming process including, but not limited to the: steel manufacturing; cement manufacturing; production of hydrogen and/or synthetic gas, such as steam-methane reforming; conversion of methane to hydrogen, fuels and/or chemicals; conversion of plastic and/or organic materials, such as plastic and/or organic waste, to useable products (recycling); thermal energy storage, such as high temperature heat storage; processes related to oil- and/or petrochemical industries; catalytic processes for endothermic reactions; processes for disposal of harmful and/or toxic substances by incineration, and processes for manufacturing high-temperature materials, such as glass wool, carbon fiber and carbon nanotubes, brick, ceramic materials, porcelain and tile.

In a further aspect, a method for inputting thermal energy into fluids is provided, the method comprising:
(a) obtaining the rotary apparatus 100 comprising:
   a rotor with two or more circumferential rows of rotor blades coaxially arranged on at least one rotor shaft Ax and forming respective rotor blade cascades R1, R2;
   at least two rows of stationary vanes adjacently disposed with regard to the rotor blade cascades R1, R2 and forming respective stationary vane cascades S1, S2, wherein a first stationary vane cascade S1 is arranged upstream of a first rotor blade cascade R1, and wherein a second stationary vane cascade S2 is arranged downstream of a rearmost rotor blade cascade R2; and
   a casing GC, in which a duct Es2 is formed with at least one inlet In, In1, In2 and at least one outlet Out, Out1, Out2, said casing enclosing rotor blade cascades R1, R1 and stationary vane cascades S1, S2 inside the duct,
(b) adjusting rotational speed and optionally direction of at least one rotor shaft to a predetermined speed or a speed range to reach the fluidic medium flow rate that satisfies the requirements imposed by the process;
(c) adjusting a preheating level of the fluidic medium;
(d) feeding fluidic medium into the rotary apparatus through at least one inlet, whereupon the cascades S1, R1, R2, S2 begin directing a stream of fluidic medium to repeatedly pass through said cascades according to essentially helical trajectory, while propagating in the duct between inlet(s) and outlet(s),
   wherein the stream of fluidic medium is heated by virtue of series of energy transformations occurring when said stream of fluidic medium successively passes through blade/vane rows formed by at least: the first stationary vane cascade (S1), the rotor blade cascades R1, R2, the second stationary vane cascade S2, and further through a portion of the duct between an exit from the second stationary vane cascade S2 and an entrance to the first stationary vane cascade S1, respectively; and
(e) discharging heated fluidic stream from the rotary apparatus through at least one outlet.

In an embodiment, in said method, the rotary apparatus further comprises a flow turn cascade, FTC, configured as a stationary vane cascade and arranged between successive coaxial rotor blade cascades R1, R2, whereby the fluid is heated inside the duct when the stream of fluidic medium repeatedly passes, in accordance with essentially helical trajectory, through a cascade arrangement formed with: the first stationary vane cascade (S1), the first rotor blade cascade (R1), the flow turn cascade (FTC), the second rotor blade cascade (R2), the second stationary vane cascade (S2), and the portion of the duct between the exit from the second stationary vane cascade (S2) and the entrance to the first stationary vane cascade (S1), respectively.

It is clear to a person skilled in the art that with the advancement of technology the basic ideas of the present invention may be implemented in various ways. The invention and its embodiments may generally vary within the scope of the appended claims.

1. A rotary apparatus (100) comprising:
a rotor comprising two or more circumferential rows of rotor blades coaxially arranged on at least one rotor shaft (Ax) and forming respective rotor blade cascades (R1, R2),
at least two rows of stationary vanes adjacently disposed with regard to the rotor blade cascades (R1, R2) and forming respective stationary vane cascades (S1, S2), wherein a first stationary vane cascade (S1) is arranged upstream of a first rotor blade cascade (R1), and wherein a second stationary vane cascade (S2) is arranged downstream of a rearmost rotor blade cascade (R2); and
a casing (GC), in which a duct (Es2) is formed with at least one inlet (In, In1, In2) and at least one outlet (Out, Out1, Out2), said casing enclosing rotor blade cascades (R1, R1) and stationary vane cascades (S1, S2) inside the duct,
wherein said cascades (S1, R1, R2, S2) are configured to direct a stream of fluidic medium propagating in the duct between at least one inlet and at least one outlet to repeatedly pass through said cascades according to essentially helical trajectory, and to heat the stream of fluidic medium by virtue of series of energy transformations occurring when said stream of fluidic medium successively passes through blade/vane rows formed by at least: the first stationary vane cascade (S1), the rotor blade cascades (R1, R2), the second stationary vane cascade (S2), and further through a portion of the duct between an exit from the second stationary vane cascade (S2) and an entrance to the first stationary vane cascade (S1), respectively.

2. The rotary apparatus (100) of claim 1, wherein the first stationary blade cascade (S1) is configured as a guide vane cascade (GVC) formed with a plurality of stationary guide vanes, and the second stationary vane cascade is configured as a diffusing cascade (DC) formed with a plurality of stationary diffusing vanes.

3. The rotary apparatus (100) of claim 1, further comprising a flow turn cascade (FTC) configured as a stationary vane cascade and arranged between successive coaxial rotor blade cascades (R1, R2).

4. The rotary apparatus (100) of claim 3, wherein the flow turn cascade (FTC) is configured to turn the stream of fluidic medium exiting the first rotor blade cascade (R1) and to direct it towards a subsequent rotor blade cascade (R2).

5. The rotary apparatus (100) of claim 1, wherein each of the rotor blade cascades (R1, R2) comprises a rotor blade cascade specific number (n), (m) of rotor blades (202), (204), respectively, and wherein each of the stationary vane cascades (S1, S2, FTC) comprises a stationary vane cascade specific number (q), (k), (p) of stationary vanes (201), (203), (205), respectively.

6. The rotary apparatus (100) of claim 1, wherein the rotor blade cascades (R1, R2) are arranged on same rotor shaft configured to rotate in a predetermined direction.

7. The rotary apparatus (100) of claim 1, wherein the rotor blade cascades (R1, R2) are arranged on connected, coaxially aligned rotor shafts.

8. The rotary apparatus (100) of claim 7, wherein direction of rotation and/or angular velocity of each rotor blade cascade (R1, R2) is independently regulated.

9. The rotary apparatus (100) of claim 7, wherein said coaxially aligned shafts are configured for counter-rotation.

10. The rotary apparatus (100) of claim 1, wherein the stationary vane cascades (S1, S2, FTC) are coaxially centered with the rotor blade cascades (R1, R2) arranged on the same rotor shaft or on separate, coaxially aligned rotor shafts.

11. The rotary apparatus (100) of claim 1, wherein the portion of the duct between the exit from the second stationary vane cascade (S2) and the entrance to the first stationary vane cascade (S1) is essentially free of blades/vanes.

12. Use of the apparatus (100) as defined in claim 1 for generation of fluidic medium heated to the temperature essentially equal to or exceeding about 400 degrees Celsius (° C.).

13. Use of the apparatus (100) as defined in claim 1 for heat-assisted conversion of feedstocks in fluidic media, optionally, as a reactor for thermal- or thermochemical cracking of hydrocarbon-containing feedstocks.

14. An assembly comprising at least two rotary apparatuses (100) according to claim 1, at least functionally connected in parallel or in series.

15. An arrangement comprising at least one rotary apparatus (100) according to claim 1 connected to at least one heat-consuming unit.

16. The arrangement of claim 15, wherein the heat-consuming unit is any one of: a furnace, an oven, a kiln, a reactor, a heater, a burner, an incinerator, a boiler, a dryer, a conveyor, or a combination thereof.

17. A method for inputting thermal energy into fluids, comprising:
(a) obtaining a rotary apparatus (100) comprising:
a rotor with two or more circumferential rows of rotor blades coaxially arranged on at least one rotor shaft (Ax) and forming respective rotor blade cascades (R1, R2),
at least two rows of stationary vanes adjacently disposed with regard to the rotor blade cascades (R1, R2) and forming respective stationary vane cascades (S1, S2), wherein a first stationary vane cascade (S1) is arranged upstream of a first rotor blade cascade (R1), and wherein a second stationary vane cascade (S2) is arranged downstream of a rearmost rotor blade cascade (R2); and
a casing (GC), in which a duct (Es2) is formed with at least one inlet (In, In1, In2) and at least one outlet (Out, Out1, Out2), said casing enclosing rotor blade cascades (R1, R1) and stationary vane cascades (S1, S2) inside the duct,
(b) adjusting rotational speed and optionally direction of at least one rotor shaft to a predetermined speed or a speed range to reach the fluidic medium flow rate that satisfies the requirements imposed by the process;
(c) adjusting a preheating level of the fluidic medium;
(d) feeding fluidic medium into the rotary apparatus through at least one inlet, whereupon the cascades (S1, R1, R2, S2) begin directing a stream of fluidic medium to repeatedly pass through said cascades according to essentially helical trajectory, while propagating in the duct between inlet(s) and outlet(s),
wherein the stream of fluidic medium is heated by virtue of series of energy transformations occurring when said stream of fluidic medium successively passes through blade/vane rows formed by at least: the first stationary vane cascade (S1), the rotor blade cascades (R1, R2), the second stationary vane cascade (S2), and further through a portion of the duct between an exit from the second stationary vane cascade (S2) and an entrance to the first stationary vane cascade (S1), respectively;
and
(e) discharging heated fluidic stream from the rotary apparatus through at least one outlet.

18. The method of claim 17, wherein the rotary apparatus further comprises a flow turn cascade (FTC) configured as a stationary vane cascade and arranged between successive coaxial rotor blade cascades (R1, R2), and wherein the fluid is heated inside the duct when the stream of fluidic medium repeatedly passes, in accordance with essentially helical trajectory, through a cascade arrangement formed with: the first stationary vane cascade (S1), the first rotor blade cascade (R1), the flow turn cascade (FTC), the second rotor blade cascade (R2), the second stationary vane cascade (S2), and the portion of the duct between the exit from the second stationary vane cascade (S2) and the entrance to the first stationary vane cascade (S1), respectively.

19. The method of claim 17, wherein the fluidic medium comprises any one of: a feed gas, a recycle gas, a make-up gas, and a process fluid.

20. The method of claim 17, wherein the fluidic medium comprises hydrocarbon-containing process fluids.

21. The method of claim 17, wherein the fluidic medium enters the rotary apparatus in an essentially gaseous form.

22. The method of claim 17, wherein fluidic medium discharged from the rotary apparatus 100 has exit temperature of at least about 400 degrees Celsius (° C.).

23. The method of claim 17, wherein thermal treatment of the fluids comprises thermal- or thermochemical cracking of hydrocarbon-containing feedstocks.
